(19) United States
(12) Patent Application Publication
(10) Pub. No.: US 2011/0020783 A1
(43) Pub. Date: Jan. 27, 2011

(54) ORGANIZER MESSAGE BOARD

(76) Inventor: Tsachi Davidov, Neve Monson (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 12/161,176

(22) PCT Filed: Jan. 23, 2007
(86) PCT No.: PCT/IL07/00085

§ 371 Date: Jul. 17, 2008

Related U.S. Application Data
(60) Provisional application No. 60/760,963, filed on Jan. 23, 2006.
(60) Provisional application No. 60/777,542, filed on Mar. 1, 2006.
(60) Provisional application No. 60/841,232, filed on Aug. 31, 2006.
(60) Provisional application No. 60/865,879, filed on Nov. 15, 2006.
(60) Provisional application No. 60/865,873, filed on Nov. 15, 2006.

(51) Int. Cl. G09B 29/00

(52) U.S. Cl. 434/430

(57) ABSTRACT

An article including a message board adapted for writing and posting messages thereon, and an office equipment device built into the message board.

### FIELD OF THE INVENTION

The present invention relates generally to message boards, such as magnetic boards, white boards, bulletin boards, cork boards and chalk boards, and particularly to a message board with office equipment built into the board.

### BACKGROUND OF THE INVENTION

There are in common use, in homes, offices and factories, many types of message boards that can be used for handy recording of short messages, such as one taken over the telephone that contains only the party's name and number. One common device simply attaches to a wall or vertical surface and comprises a multi-page paper pad on which a message may be written with a pencil or pen. One construction of these noteboards that has become popular is the provision of a magnet on the rear surface of the pad that allows the pad to be attached to a metallic refrigerator door in the kitchen of a home.

There are also in common use so-called “whiteboards” that are used primarily in offices and business areas for temporarily recording information, These boards have an opaque surface and are written on using a dry-erase pen that deposits ink on the surface. The whiteboard surface is designed to retain the ink but to also allow the ink to be easily wiped off using a cloth or paper tissue or similar dry eraser. Such devices are also made with permanent recorded information on the surface that is painted, stenciled or otherwise applied. Such information may include a calendar showing the days of a month, or months of the year which may then be used to record, using the dry-erase pen, additional hand written information relative to appointments, scheduling, or the like. The white board permanent information may also contain an advertising message or the name of a company, with an address and telephone number to promote the company's services or products.

### SUMMARY OF THE INVENTION

The present invention seeks to provide a message board, such as magnetic boards, white boards, bulletin boards, cork boards and chalk boards, with office equipment built into the board, as is described in detail further hereinbelow.

### BRIEF DESCRIPTION OF THE DRAWINGS

The present invention will be understood and appreciated more fully from the following detailed description taken in conjunction with the drawing in which:

FIGS. 1 and 2 are simplified pictorial and sectional illustrations, respectively, of a message board, constructed and operative in accordance with an embodiment of the present invention, FIG. 2 being taken along lines II-II in FIG. 1;

FIG. 3 is a simplified pictorial illustration of a message board, constructed and operative in accordance with another embodiment of the present invention, comprising pull-out drawing aids;

FIGS. 4A and 4B are simplified pictorial illustrations of drawings aids of the message board of FIG. 3, wherein the drawings aids are attached to or nested with one another as they are pulled out from the board; and

FIG. 5 is a simplified pictorial illustration of a message board, constructed and operative in accordance with another embodiment of the present invention, comprising a corner tape dispenser which is positioned at and forms one corner of the board and other devices.

### DETAILED DESCRIPTION OF EMBODIMENTS

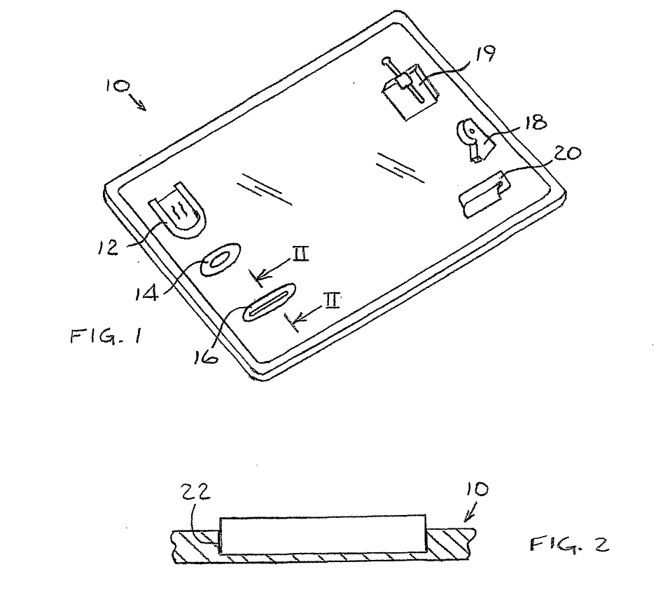

Reference is now made to FIG. 1, which illustrates a message board 10, constructed and operative in accordance with an embodiment of the present invention.

Throughout the specification and claims, the term “message board” encompasses any surface for posting messages thereupon, such as but not limited to, magnetic boards, white boards, bulletin boards, blackboards, chalk boards, cork boards and the like. The term “whiteboard” refers to any plastic glossy surface, most commonly colored white, where markings can be made. Whiteboards operate analogously to blackboards, they allow markings that temporarily adhere to the surface of the board and that can be easily removed.

Message board 10 may have office equipment built in. The office equipment may comprise, without limitation, a card (e.g., business card) holder 12, a clip holder 14, a pad holder 16, a tape dispenser 18, pen holder 19 and/or a pop-up repositionable note dispenser 20. Message board 10 may be supplied with any number and combination of the office equipment devices, and of course still has space for writing messages thereon. The dispenser 20 may comprise any dispenser used for dispensing POST-IT notes, such as but not limited to, fan folded adhesive sticky notes. The office equipment may be built into the board 10 such as by being mounted in a groove or other cut-out portion 22 formed in board 10, as seen in FIG. 2. The cut-out portion 22 may be blind, that is, it does not go through the thickness of board 10. In this manner, the remaining portion of board 10 serves as the backing for the office equipment device. In one embodiment, the office equipment device may be embedded in the board 10 and fixed thereto, such as by means of mechanical fasteners or adhesive. Alternatively, the office equipment device may be fixed to the outside surface of message board 10, such as by means of mechanical fasteners or adhesive.

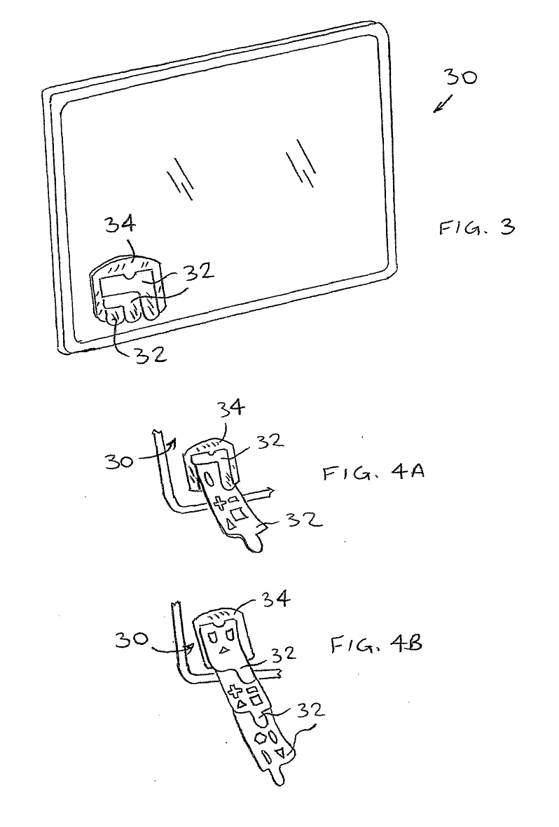

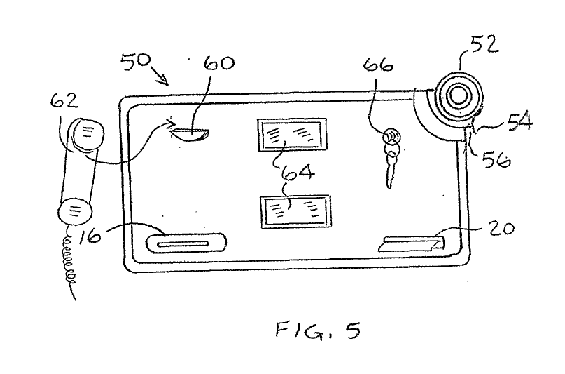

Reference is now made to FIG. 3, which illustrates a message board 30, constructed and operative in accordance with another embodiment of the present invention. Message board 30 may be constructed like the other message boards of the invention and may further include pull-out drawing aids 32, such as various templates, stencils, etc. As further seen in FIGS. 4A and 4B, the drawings aids 32 may be disposed in a dispenser 34 and may be attached to or nested with one another, even as they are pulled out from the board 30. As similarly described above for the embodiments of FIG. 2, dispenser 34 may be built into the board 30 such as by being mounted in a groove or other cut-out portion formed in the board 30.

Reference is now made to FIG. 5, which illustrates a message board 50, constructed and operative in accordance with another embodiment of the present invention. Message board 50 may be constructed like the other message boards of the invention and may further include a corner tape dispenser 52 which is positioned at and forms one corner of the board. Corner tape dispenser 52 may dispense any kind of tape 54, such as but not limited to clear tape, insulating tape, masking tape and the like. The corner tape dispenser 52 may include a sharp edge 56 for cutting the tape 54, wherein the sharp edge 56 points out to the side of the board 50.

Message board 50 may also have a built-in telephone support 60. The support 60 may support a portion of a telephone 62, such as but not limited to, the earpiece of the receiver of the handset. The telephone may be held on the board and plugged into any regular telephone jack. The telephone may be a regular, wired telephone, cordless telephone or mobile telephone, for example.

The message board 50 may also have one or more built-in loudspeakers 64. The loudspeakers may be connected to a personal computer or stereo system, or any other equipment that uses loudspeaker, by means of a connector, such as but not limited to, a USB connector or jack. The loudspeakers may be framed in a variety of shapes and colors.

The remainder of the board may comprise other office equipment as described in other embodiments, such as, without limitation, a magnetic key holder 66, a card (e.g., business card) holder, a clip holder, a pad holder, a tape dispenser, pen holder and/or a pop-up repositionable note dispenser. Message board 10 may be supplied with any number and combination of the office equipment devices, and of course still has space for writing messages thereon. The dispenser 20 may comprise any dispenser used for dispensing POST-IT notes, such as but not limited to, fan folded adhesive sticky notes.

It is appreciated that various features of the invention which are, for clarity, described in the contexts of separate embodiments, may also be provided in combination in a single embodiment. Conversely, various features of the invention which are, for brevity, described in the context of a single embodiment, may also be provided separately or in any suitable subcombination.

What is claimed is:

1. An article comprising:
a message board adapted for writing and posting messages thereon; and
an office equipment device built into said message board.

2. The article according to claim 1, wherein said office equipment device is mounted in a cut-out portion formed in said message board.

3. The article according to claim 2, wherein said cut-out portion does not fully go through a thickness of said message board.

4. The article according to claim 1, wherein said office equipment device is embedded in said message board and fixed thereto.

5. The article according to claim 1, wherein said office equipment device is fixed to an outside surface of said message board.

6. The article according to claim 1, wherein said office equipment device comprises at least one of a card holder, a clip holder, a pad holder, a tape dispenser, a pen holder, pull-out drawing aids and a pop-up repositionable note dispenser.

7. The article according to claim 6, wherein said pop-up repositionable note dispenser is adapted to dispense fan folded adhesive sticky notes.

8. The article according to claim 6, wherein said pull-out drawing aids are nested with one another.

9. The article according to claim 1, wherein said office equipment device comprises a telephone support.

10. The article according to claim 1, wherein said office equipment device comprises a loudspeaker.
